(19) United States
(12) Patent Application Publication
(10) Pub. No.: US 2012/0148840 A1
(43) Pub. Date: Jun. 14, 2012

(54) LONG-FIBER-REINFORCED POLYMER MATERIAL AND METHOD AND INSTALLATION FOR ITS MANUFACTURE

(76) Inventor: David Stirnemann, Baden (CH)

(21) Appl. No.: 13/391,071

(22) PCT Filed: Aug. 23, 2010
(86) PCT No.: PCT/CH10/00204

§ 371 Date: Feb. 17, 2012

(30) Foreign Application Priority Data
Aug. 24, 2009 (CH) 1306/09

(51) Int. Cl. D02G 3/26; B29B 9/02; C08F 110/06; C08F 136/02; C08G 63/199; C08G 59/00; C08G 63/00; C08G 18/06; B29B 9/14; C08G 69/00

(52) U.S. Cl. 428/370; 264/136; 425/90; 526/351; 528/271; 528/307; 528/418; 528/85; 526/335

(57) ABSTRACT

The fiber-reinforced polymer material, in particular for processing in the injection molding and extrusion method, is composed of granular materials having integrated long-fiber reinforcement. The granular materials are designed as wound elements (5), which have continuous fiber strands (3) including continuous reinforcing fibers (1) impregnated with polymer material (2). The wound elements (5) contain more than one turn (6) of the impregnated continuous fiber strands (3), wherein the turns (6) at least partially overlap each other such that the turns are arranged over each other and/or next to each other. The wound elements (5) can be continuously produced by winding and solidifying the impregnated continuous fiber strands (3) around a winding axis (23) or on a winding core (22) and subsequently separating the wound elements from each other, in particular by means of a winding core moved in an oscillating (+x1, −x1) manner and using melted thermoplastic polymer material (2).

The invention relates to a long-fiber-reinforced polymer material, in particular for processing in the injection moulding method or extrusion method, consisting of granular materials with integrated long-fiber reinforcement, according to the preamble of claim 1, as well as to a method and to an installation for manufacturing this long-fiber-reinforced polymer material. Materials known for application in injection moulding methods and extrusion methods are short-fiber-reinforced polymer material in the form of granular materials with 0.1 to 5 mm fiber length and long-fiber-reinforced polymer material in the form of rod-like granular materials with fiber lengths of 5 mm to 50 mm, wherein rod-like granular materials more than 25 mm long can only be processed with modified, large, special plasticisation assemblies. One usually obtains lengths of 10 mm, 12 mm or 25 mm. Non-continuous winding methods, e.g. for manufacturing containers and pipes with continuous fiber rovings, are known as methods for manufacturing components with very long fibers. A special injection moulding installation is known e.g. from WO 00/37233, with which a continuous fiber strand is mixed into the compounder and is injected in a directly discontinuous manner (in-line compounding). This method however basically necessitates special complicated, expensive injection moulding installations.

Long fibers in the resulting injection moulded components can only be achieved to a very limited extent with the known polymer materials. When processing known rod-like granular materials with screw plasticisation assemblies, the relatively long fibers are subjected to high shear loads which lead to most of the long fibers being broken and massively shortened. Moreover, the maximal fiber length is also limited by the length of the rod-like granular material. This problem of the shortening of the fibers, above all on feeding and in the solid-matter conveyor region of screw machines, has not been solved to this date. The problem becomes more acute, the smaller are the applied screw diameters. In particular, the processing of LFT rod-like granular materials with screw diameters below 60 mm is not possible today without changes with regard to the machine.

It is therefore the object of the present invention, to overcome the disadvantages and limitations of the known long-fiber-reinforced polymer materials and to provide a continuously manufacturable, long-fiber-reinforced polymer material which after the processing, in particular permits much longer fibers in the component and thus much better mechanical properties than was previously the case. This above all should also permit the processing on existing, smaller injection moulding installations and extrusion installations with smaller screw diameters, even of less than 45 mm.

According to the invention, this object is achieved by a long-fiber-reinforced polymer material according to claim 1, by a method according to claim 11, and by an installation according to claim 18 for the continuous manufacture of the long-fiber-reinforced polymer material as well as by a component and a method for manufacturing a component with wound elements. With the shaping and construction of the wound elements according to the invention, much greater fiber lengths and a much greater share of long fibers are achieved in the components manufactured with these, and thus the mechanical properties of these components such as strength, stiffness and impact strength are greatly improved. The shaping of the wound elements on the one hand results in large fiber lengths in the compact round granular material and on the other hand permits a gentle processing with less fiber breakages and thus greater fiber lengths in the component.

The dependent patent claims relate to advantageous further formations of the invention with particular advantages with respect to the rational manufacture, processing and optimal characteristics or properties of the long-fiber-reinforced polymer material in the form of wound elements, and significantly better mechanical properties of the components manufactured with this.

The invention is hereinafter explained further by way of embodiment examples and figures, and thereby there are shown in:

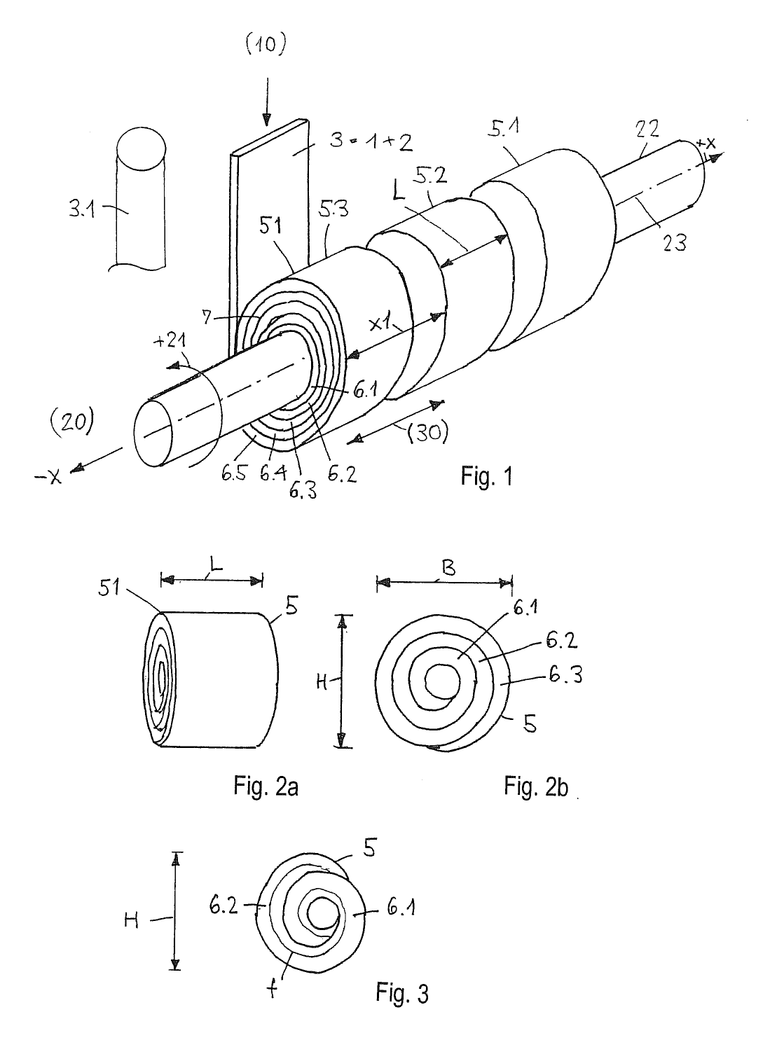

FIG. 1 schematically, a manufacture of granular materials according to the invention, with long-fiber reinforcement in the form of wound elements,

FIG. 2a, b an example of a wound element with three turns lying over one another,

FIG. 3 a further example of a wound element with 1½ turns,

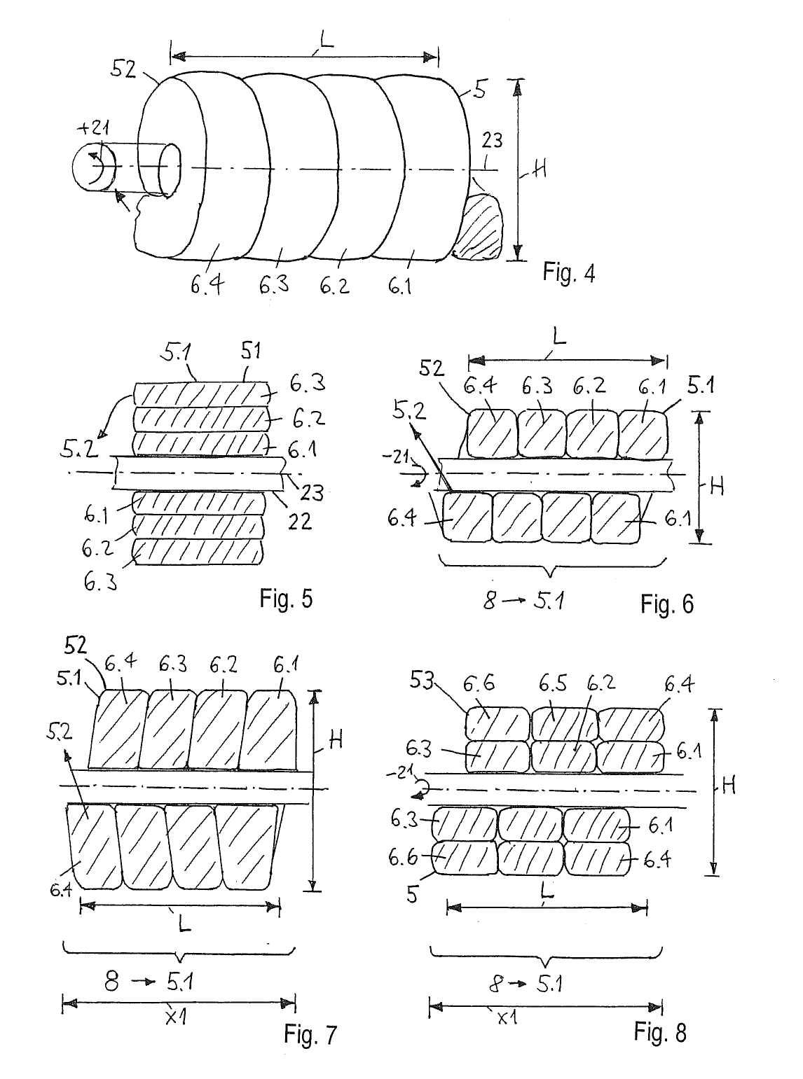

FIG. 4 an example of a wound element with turns lying next to one another,

FIG. 5-8 different examples of wound elements with turns lying over one another and next to one another,

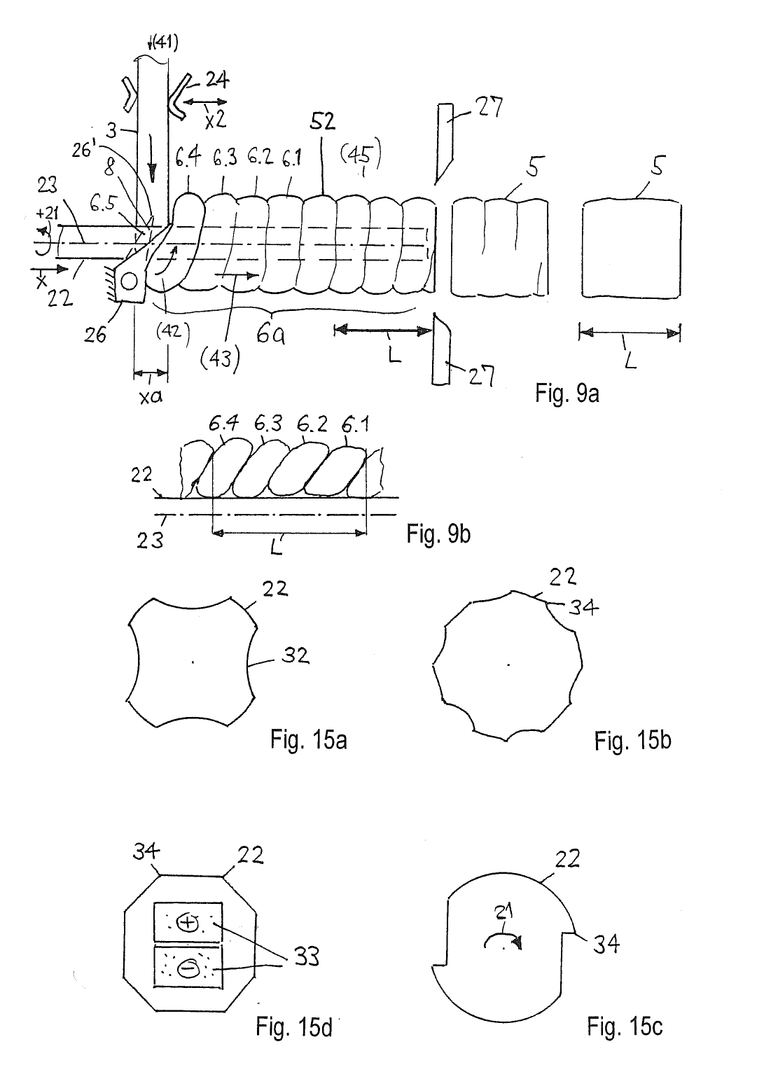

FIG. 9a a manufacture of wound elements by way of forming windings on a winding core,

FIG. 9b a wound element with turns partly lying over one another,

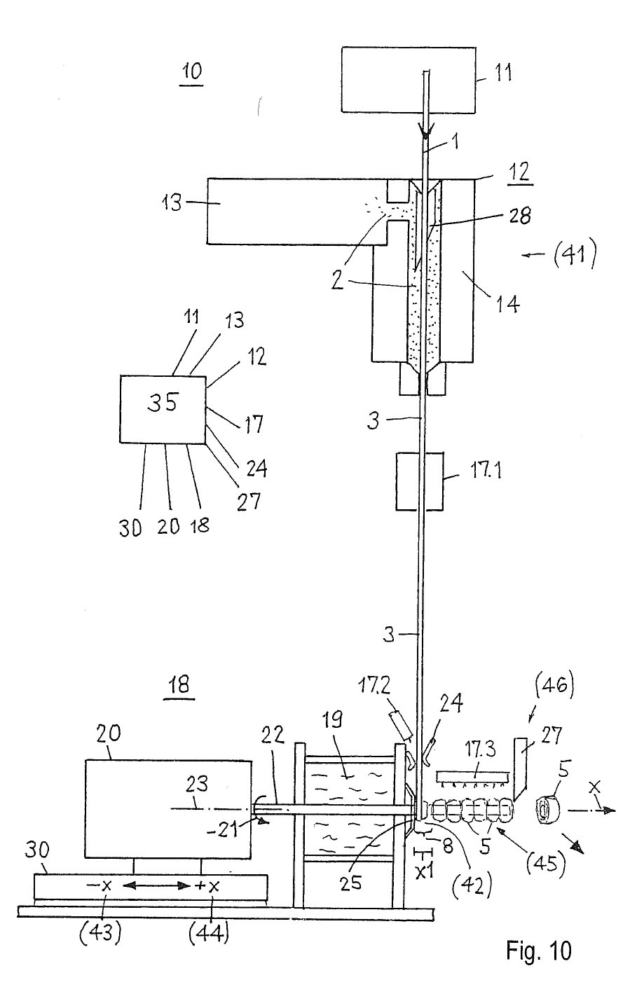

FIG. 10 an installation for the continuous manufacture of wound elements,

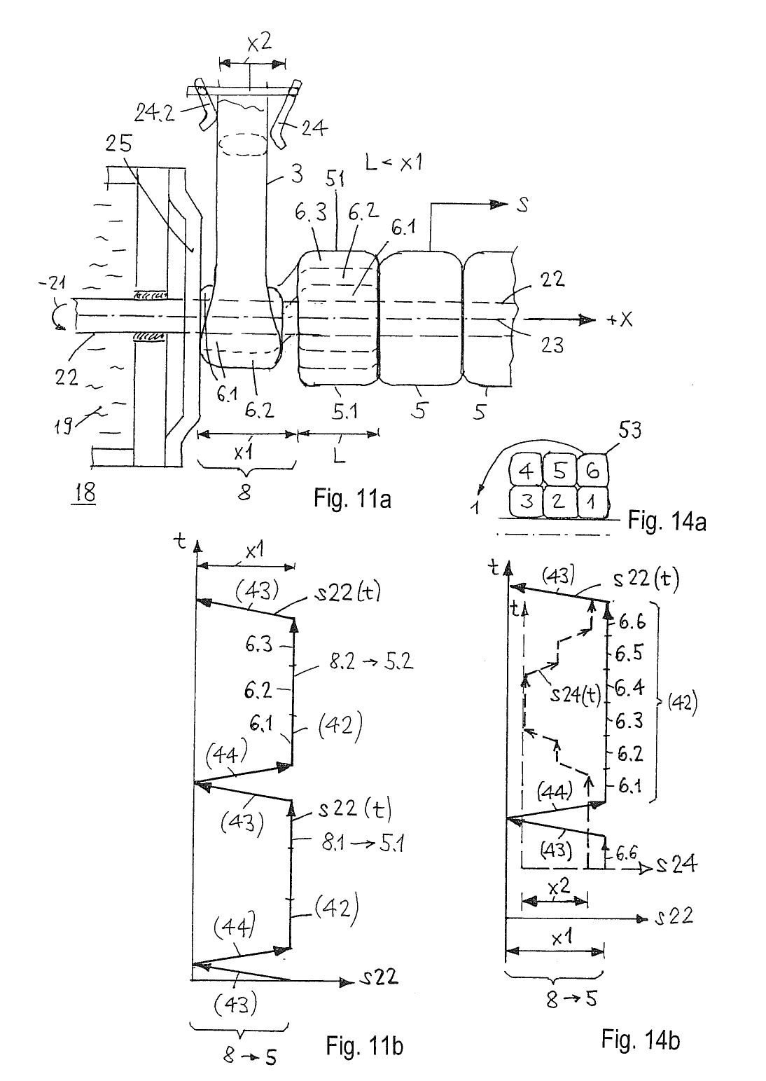

FIG. 11a,b a manufacture of wound elements with turns lying over one another,

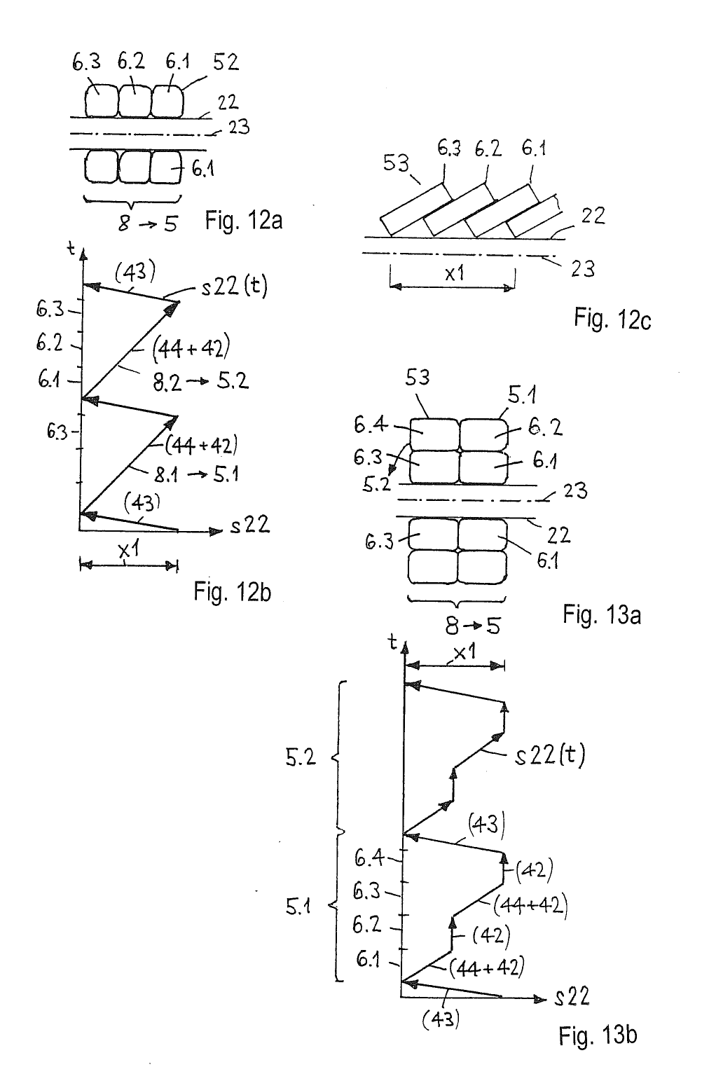

FIG. 12a, b a manufacture of wound elements with turns lying next to one another,

FIG. 12c a manufacture of wound elements in mixed form,

FIG. 13a, b a manufacture of wound elements with turns lying over one another and next to one another,

FIG. 14a, b a manufacture of wound elements with an additional displacement of the running-in, impregnated continuous fiber strand,

FIG. 15a-d different examples of winding cores,

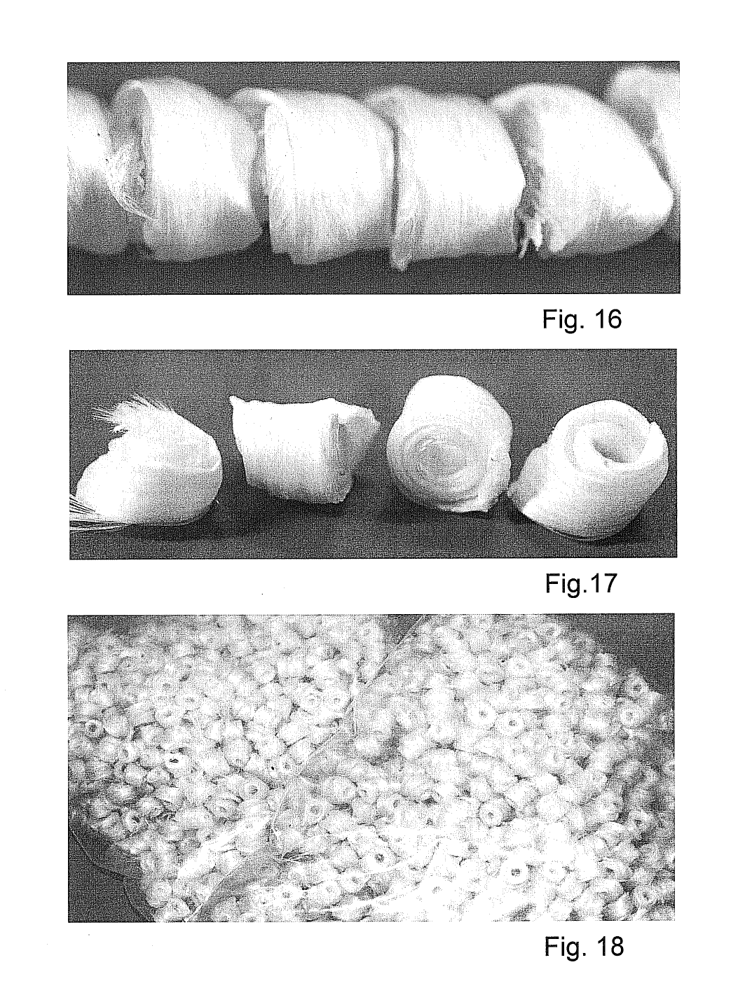

FIG. 16 several continuously manufactured wound elements before the separation,

FIG. 17 individual wound elements as a fourfold curl,

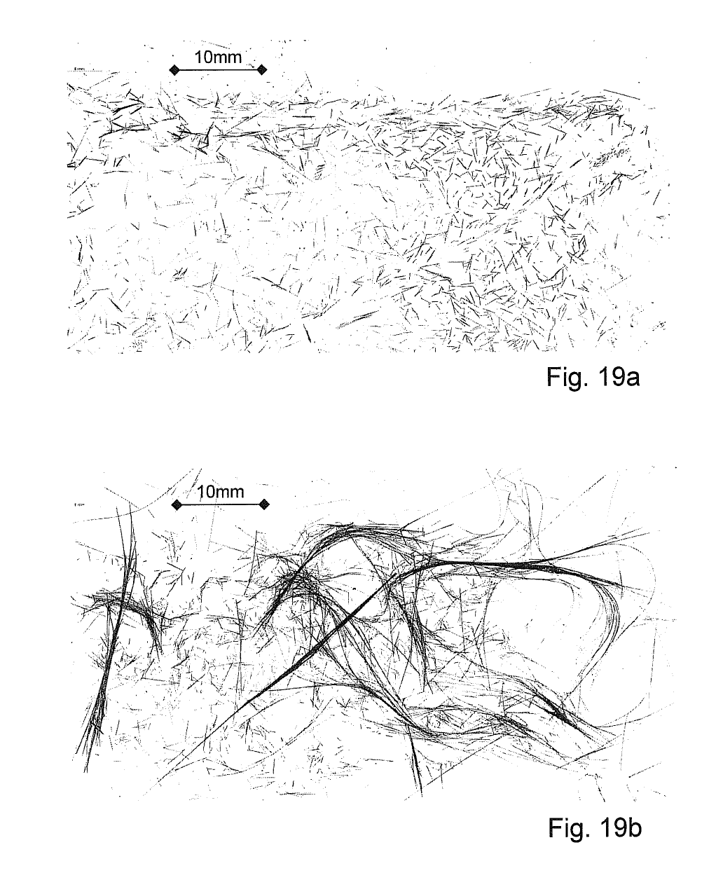

FIG. 18 wound elements as a granular material,

FIG. 19 the resulting fiber lengths in an injection moulded part, in comparison:

FIG. 19a-manufactured from known rod-like granular materials,

FIG. 19b-manufactured from wound elements according to the invention, as a granular material,

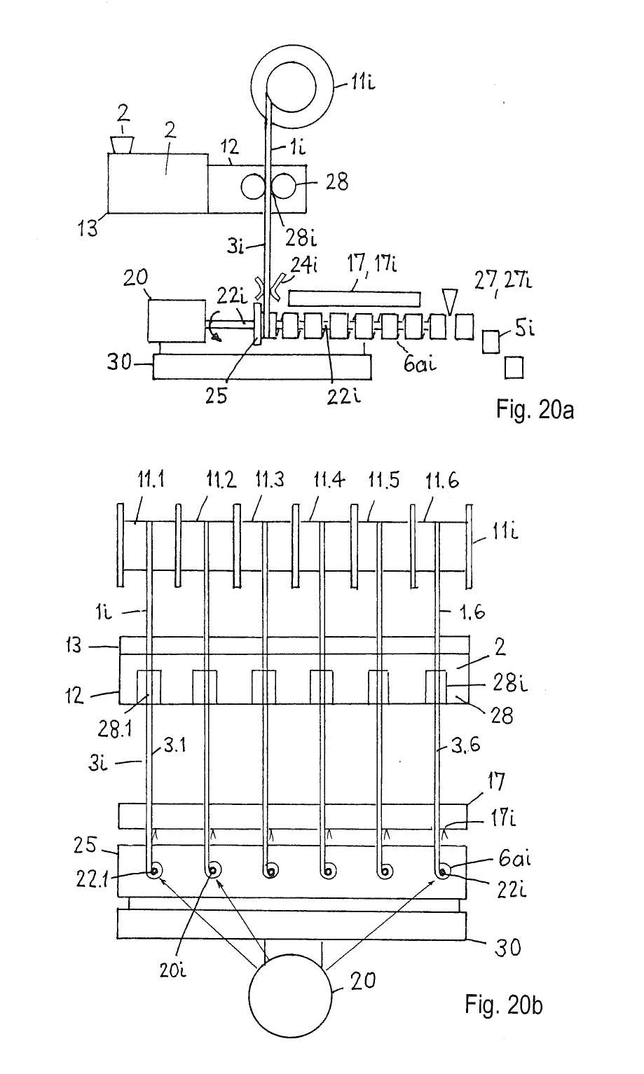

FIG. 20a, b a multiple winding installation with many winding locations,

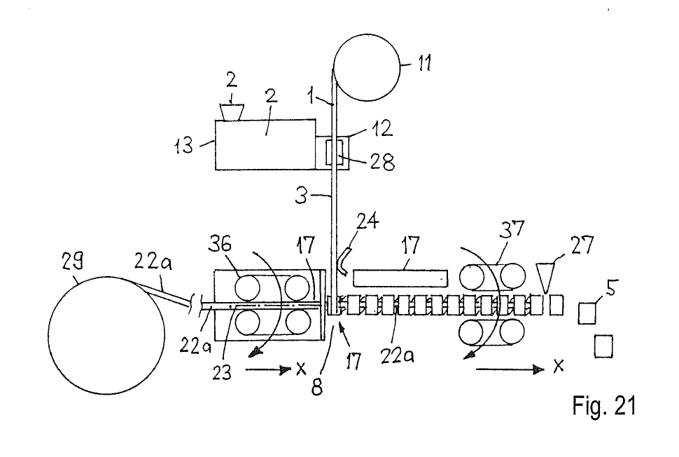

FIG. 21 an installation with a winding core of polymer material.

FIG. 1-8 show different examples of wound elements 5 according to the invention,

FIG. 9-14 illustrate methods and installations for the continuous manufacture of granular material consisting of wound elements 5.

FIGS. 16-19 show pictures of continuously manufactured wound elements and the resulting, very large fiber lengths in an injection moulded part manufactured from wound elements 5.

FIG. 1 schematically shows a continuous manufacture of fiber-reinforced polymer material, in particular for processing in the injection moulding method and extrusion method, consisting of granular materials with integrated long-fiber reinforcement, wherein the granular materials of polymer material are formed as wound elements 5. The wound elements 5 comprise continuous fiber strands 3 of continuous reinforcement fibers 1 impregnated with polymer material 2, wherein the wound elements 5 contain more than one turn 6 of the impregnated continuous fiber strands 3, and the turns 6 in the wound elements 5 at least partly overlap 7, by way of them being arranged lying over one another and/or next to one another. The continuous manufacture of these wound elements 5 is described in a detailed manner with regard to the FIGS. 9-14, 20, 21.

FIG. 1 shows an impregnated continuous fiber strand 3 which is wound onto a rotating winding core 22 for forming wound elements 5.1, 5.2, 5.3, in each case with five turns 6.1-6.5 which lie over one another and which overlap (7). The wound elements 5 are advanced on the winding core 22 in a stepped manner in the +x-direction of the winding axis 23 and are solidified (FIG. 10, 11) and subsequently separated form one another by way of a cutting device. The running-in, impregnated continuous fiber strand 3 can e.g. have a flat cross-sectional shape or also a round shape 3.2, e.g. for turns according to FIG. 4 which lie next to one another, depending on the desired shape of the wound elements 5.

The wound elements 5 according to the invention can comprise turns 6 lying over one another=curled 51 (according to FIGS. 1-3, 5, 10, 11, 16-18), turns lying next to one another=spiral-shaped 52 (according to FIG. 4, 6, 7, 9a, 12) or turns lying over one another and next to one another, in a combined manner=53 (according to FIG. 8, 9b, 12c, 13, 14). The wound elements 5 preferably comprise turns lying at least partly over one another for many applications.

On advancing and melting the wound elements 5 in a compounder of a shaping process (e.g. injection moulding), curled wound elements 51 with turns lying over one another maintain their shape longer, the turns are broken up less rapidly and are mixed through less rapidly than with spiral-shaped wound elements 52 with turns lying next to one another. The curled wound elements 51 therefore tend to have particularly less fiber breakages with accordingly longer fibers in the components and are intermixed to a lesser extent, whilst the spiral-shaped wound elements 52 tend to break up more rapidly, to have a greater intermixing, but less long fibers in the component—not as long as with curled wound elements—but much longer that with granular materials until now.

With mixed forms 53 of the wound elements, with turns lying to some extent over one another and to some extent next to one another, as well as by way of the number and size of the turns in the wound elements, one can influence and optimise the desired characteristics in the component manufactured therefrom (fiber length, distribution, degree of mixing).

Curled wound elements 51 are particularly suitable for achieving as large as possible fiber lengths in a component.

FIG. 2a, b in two views show a wound element 5 with three turns 6.1, 6.2, 6.3 lying over one another, with the linear dimensions L=length, B=width, H=height. The wound elements 5 have an as compact as possible, round shape, in the broadest sense approximated to a ball shape or square cylinder shape. With this, relatively very large fiber lengths f which amount to a multiple of the fiber lengths of known long-fiber granular materials can be produced in a relatively small volume of the granular material.

FIG. 3 shows an example of a wound element 5 with only 1½ turns 6.1, 6.2 lying over one another. Already with this, one can achieve fiber lengths f which amount to threefold of the linear dimension H. The wound elements 5 can advantageously each have at least two turns 6, preferably three to eight turns.

FIG. 4 shows an example with four turns 6.1-6.4 lying next to one another=spiral-shaped wound element 52.

FIGS. 5-8 in cross section of a winding core 22 with a winding axis 23 show further examples of wound elements 5 with turns 6 lying over one another and next to one another. FIG. 5 shows a wound element 5.1 with three turns 6.1-6.3 lying over one another, FIG. 6 a wound element with four turns 6.1-6.4 lying next to one another and FIG. 7 a wound element with four compacted turns 6.1-6.4 lying next to one another, i.e. each subsequent turn here lies partly on the previous turn. The ratio of the height H to the length L=H/L can be increased by way of this.

FIG. 8 shows a wound element 5 as a combined form 53, with three turns lying next to one another and three turns lying thereabove. The turns 6.4-6.6 are wound over the turns 6.1-6.3. The manufacture of these different types of wound elements is described further with regard to FIGS. 11-14.

The wound elements 5 can preferably have a ratio of maximum/minimum of the linear dimensions (L, B, H): max (L, B, H)/min (L, B, H) of at the most 2-3. These linear dimensions L, B, H of the wound elements can be 5-20 mm for most applications, wherein larger dimensions are also possible.

The wound elements according to the invention can basically comprise polymer material 2 of all types. The wound elements can advantageously be applied in thermoplastic manufacturing methods and accordingly comprise thermoplastic polymer material 2 of the known type, e.g. with thermoplasts such as polypropylene PP, polyamides PA, technical and high-performance polymers, new e.g. PCTG=polycyclohexandimethylenterphthalate etc. However, duromers such as epoxides EP, polyester UP etc. can also be applied as a polymer material 2 for the wound elements 5, depending on the application. Elastomers such as polyurethane, EPDM etc. can also be applied as polymer material 2.

One can achieve good mechanical characteristics with a fiber share of 10-70%, preferably 20-60% by weight and with fiber lengths f of more than 25 mm of the impregnated continuous fiber stands 3 in the wound elements 5, wherein fiber lengths of 200 mm and more are also possible depending on the application. As is known, glass fibers, carbon fibers, aramide fibers etc. can be applied as reinforcement fibers. The wound elements 5 apart from the impregnated continuous fiber strands 3 can also yet contain additional polymer material 2. Pure polymer material 2 can also be admixed to the wound elements as a granular material (with high fiber content) and thus the end fiber content in the component manufactured with this can be set.

FIGS. 9-11 show installations and methods for the continuous manufacture of wound elements 5 according to the invention, on a rotating winding core 22.

FIG. 9 illustrates a continuous manufacture of windings 6a, which are cut up into individual wound elements 5 after the solidification.

FIGS. 10 and 11 show a continuous manufacture of wound elements 5 by way of retracting and advancing an oscillating, rotating winding core 22 about a path x1.

FIG. 9a shows a part of an installation, analogously to FIG. 10, for manufacturing wound elements by way of the formation of continuous windings 6a with a winding core 22 which here rotates in the clockwise direction +21 and onto which a running-in, impregnated continuous fiber strand 3 is continuously wound. The continuous fiber strand 3 running in at one side (rear) is subsequently advanced at the other side (front) by way of a stationary guide element or guide plate 26, in the direction +x by a path xa, in order to make space (8) available for the running-in continuous fiber strand 3 and thus for the formation of the next turn 6.5. All already manufactured turns 6.4, 6.3 . . . form a continuous winding 6a which is displaced in the +x-direction and is thereby solidified. Subsequently, the winding 6a is cut up at defined lengths L by way of a separating device or cutting device 27, and the individual wound elements 5 with a length L are produced with this.

FIG. 9b shows an example of wound elements 5 in mixed form 53 with turns 6.1-6.4 which lie partly over one another and which can be manufactured with an installation according to FIG. 9a, for example by way of the guide element 26 advancing the running-in continuous fiber strand 3 only by half the amount xa/2 (26′), with the same rotational speed of the winding axis 23. One can also produce partly overlapping turns by way of adjusting guide elements 24.

The general method for the continuous manufacture of granular materials from long-fiber-reinforced polymer material in the form of wound elements 5 comprises the following method steps:

(41) winding off a roving of continuous reinforcement fibers 1 and impregnating with molten or liquid polymer material 2 for forming an impregnated continuous fiber strand 3,
(42) winding the impregnated continuous fiber strand 3 in turns 6 lying over one another and/or next to one another, about a winding axis 23 for forming windings 6a,
(43) and thereby displacing the formed windings in the axial direction +x,
(45) solidifying the windings 6a during the further displacement in the axial direction +x,
(46) subsequent cutting through the solidified windings 6a at defined distances L and the formation of individual wound elements 5 by way of this.

Thereby, a rotating winding core 22 can be applied as a winding axis 23.

A particularly advantageous further formation of the method comprises a periodic forwards and backward movement of the winding core 22, as is represented in the FIGS. 10-14:

The method additionally comprises a movement (−x1, +x1) of the winding core 22, which oscillates in the axial direction, with the following steps:

(42) winding the impregnated continuous fiber strand 3 for forming a wound element 5.1 in a winding position 8.1 on the winding core, subsequently
(43) retracting −x1 the winding core 22 and, by way of this, advancing the already formed wound elements 5 on the winding core and subsequently
(44) advancing +x1 the winding core and, by way of this, releasing a new winding position 8.2 for the production of a next wound element 5.2
(45) solidifying the wound elements 5 with the further advance (+x) on the winding core
(46) cutting through the impregnated continuous fiber strand 3 and with this, the separation of the individual wound elements 5 from one another.

The method according to the invention is in particular suitable for the manufacture of thermoplastic, long-fiber-reinforced polymer material. Thereby, in the method step (41), the continuous reinforcement fibers 1 are impregnated with heated, molten thermoplastic polymer material 2 and in method step (45) the wound elements 5 are cooled on the winding core 22 and solidified by way of this. This is carried out in an installation according to FIGS. 10 and 11a.

Instead of a metallic winding core 22 as part of the production installation, in a further method variant, one can also use a winding core 22a as a material to be consumed, which consists of the same thermoplastic polymer material 2 as the wound elements 5. Thereby, firstly a rod of non-reinforced or preferably reinforced polymer material 2 is formed or premanufactured, and subsequently in the cold, solid condition is used as a rotating winding core 22a for winding the molten, impregnated continuous fiber strand 3 and then in method step (46) is cut through together with the impregnated continuous fiber strand by the separating device 27. A piece of the polymer winding core 22a then together with the turns 6 form a wound element 5.

FIG. 21 shows an installation for carrying out this method. The winding core 22a is preferably manufactured by way of impregnating a continuous fiber roving with polymer material 2 analogously to the impregnated continuous fiber strands 3. With this, and by way of suitable shaping, the polymer winding core 22a should have a high torsional strength and a good contact to the molten continuous fiber strand 3 which is to be wound up. For this, the polymer winding core 22a is kept as cool as possible, before, after and at the winding location 8 by way of targeted cooling, so that it does not become soft in the inside. The rod-like winding core 22a e.g. is wound off from a reel 29 and by way of a feed device 36 is advanced to the winding location 8, is wrapped around by the impregnated continuous fiber strand 3, then greatly cooled 17 and subsequently by way of a withdrawal device 37 is advanced further in the axial direction x to a separating device 27. The feed device 36 and the withdrawal device 37 both rotate the polymer winding core 22a about the winding axis 23 and advance it in the axial direction x.

With the use of duromers or elastomers as a polymer material 2, cold-impregnated continuous fiber strands 3 are formed in the method step (41), and in method step (45) the wound elements 5 on the winding core 22 are solidified by way of heating and polymerisation.

FIG. 10 shows an installation for the continuous manufacture of granulates of long-fiber reinforced thermoplastic polymer material in the form of wound elements 5. The installation comprises the following elements:

a winding-off unit 11 for a roving of continuous reinforcement fibers 1, a subsequent melt (molten mass) feed 13 of thermoplastic polymer material 2 and a melt and impregnation device 12 for forming a molten, impregnated continuous fiber strand 3,

a winding device 18 with a winding core 22 for winding up, cooling and solidifying the impregnated continuous fiber strand 3 and for forming wound elements 5 with more than one turn 6 and turns 6 lying over one another and/or next to one another,

with a rotation motor 20 for the drive of the winding core 22 with a cooling device 19 (e.g. a water cooling)

and with a linear drive 30, with which the winding core 22 can be moved in the axial direction in an oscillating manner (−x1, +x1)

for retracting −x1 the winding core 22 and by way of this, for advancing the formed wound elements 5 on the winding core

and for the subsequent advance +x1 of the winding core, and by way of this release of a next winding position 8.2 for winding a next wound element 5.2,

with a cooling device 17 for cooling and solidifying the wound elements 5 on the winding core

and with a separating device 27 for separating the individual solidified wound elements 5 as well as with a control 35 of the installation.

The installation of FIG. 10 further comprises: a heating 14 in the melt and impregnation device 12, air coolings 17.1, 17.2, 17.3, a holding-back plate 25 for holding back the wound elements 5 on retracting the winding core 22, as well as guide plates 24, 24.2 for the running-in, impregnated continuous fiber strand 3. This is illustrated further by way of FIG. 11. One can e.g. also apply a water spray cooling for the rapid solidification of the wound elements 5 on the winding core, instead of the air cooling 17.3. The separating device 27 can be designed as a cutting device in a mechanical manner, by way of a water jet or laser.

FIG. 11a, b in a part of the installation according to FIG. 10 and in a more detailed manner, show the manufacture of wound elements 5, here with three (curled 51) turns 6.1-6.3 lying over one another, on a winding core with a rotation direction −21 (in the counter-clockwise direction). FIG. 11b shows the temporal course s22 (t) of the movement of the winding core 22 in the axial direction x: with (43) retraction by the path −x1 (with this, displacement of the formed wound elements 5.1, . . . ), (44) advance by +x1 (with this, release of the new winding position 8.2), then (42) winding the turns 6.1, 6.2, 6.3=wound element 5.2, then again (43), (44) etc. The formed wound elements 5 are pushed together by way of the retraction (43) of the winding core (22). For this reason, the winding region 8 and the path x1 is larger than the resulting length L of the wound elements 5. FIG. 11a shows adjustable guide elements or guide plates 24, 24.2 which are connected to one another and which are displaceable together in the x-direction, so that the run-in location of the impregnated continuous fiber strand 3 within the released winding position 8 is additionally displaceable (x2) for positioning the windings 6i when winding up. This is illustrated with the example of FIG. 14a, b. One can also influence the cross-sectional shape of the running-in continuous fiber strand 3 with guide plates 24, e.g. as in FIG. 1 a flat cross-sectional shape 3, a round cross-sectional shape 3.1 or a somewhat high cross-sectional shape as shown in FIG. 7.

FIG. 12a, b schematically illustrate a manufacture of wound elements with (spiral-shaped 52) turns 6.1-6.3 which lie next to one another, in an installation according to FIG. 10. The oscillating movement s22(t) of the winding core 22 runs as follows: (43) refraction by the path x1 (and release of 8.1), then advance (44) and simultaneous winding up of the turns 6.1-6.3, then refraction again (43), etc.

FIG. 12c schematically illustrates a wound element 5 in mixed form 53 manufactured in an installation according to FIG. 10, 11a, with which the turns 6.1, 6.2, 6.3 are partly wound over one another (shown schematically in FIG. 12c) by way of moving the winding core 22 according to FIG. 12b or by way of a suitable shaping or guiding of the continuous fiber strand 3 by the guide element 24, and then are yet pushed together in step 43 by way of refracting the winding core 22.

FIG. 13a, b shows the manufacture of wound elements with turns 6.1-6.4 which in a combined manner lie over one another and next to one another. According to the course of s22(t), after the retraction (43), a first advance (44) and winding (42) of the turn 6.1 is effected, thereupon then the winding of the turn 6.2, then a second advance (44) and winding of the turn 6.3 (next to the turn 6.1), then winding the turn 6.4 onto the turn 6.3, then refraction again (43) etc.

FIG. 14a, b show a manufacture of wound elements (53), with turns 6.1-6.6 lying over one another and next to one another. Here, the position of the running-in, impregnated continuous fiber strand 3 within the released winding position 8 can be additionally displaced by way of guide plates 24, 24.2 adjustable in the x-direction, as this is shown in FIG. 11a. This lateral displacement s24(t) of the guide plates is represented in FIG. 14b, additionally to the axial movement of s22(t) of the winding core, s22(t) runs analogously to the movement of the winding core in the example of FIG. 11b. During the winding (42), here the guide plates 24, 24.2 according to s24(t) are additionally displaced in a stepwise manner firstly in the direction −x (for the turns 6.1, 6.2, 6.3), then in the direction +x (for the turns 6.4-6.6). The complete displacement path s24 (t) is x2.

FIG. 15a-d show examples of winding cores 22 in cross section. The winding must be effected in the plastic (molten) condition. A high friction value in the radial direction is desired for transmitting the necessary tension force for winding from the winding core 22 onto the impregnated continuous fiber strand 3, and an as low as possible friction value is desired in the axial direction for advancing the wound elements. For this, the winding core 22 can have a suitable shaping, e.g. with grooves 32 according to FIG. 15a or with ribs and edges 34 in the winding-up direction 21 according to FIGS. 15b and 15c. The winding cores are moreover designed in a slightly conical manner in the longitudinal direction x.

The surface can comprise a smooth, wear-resistant, hard coating, e.g. of titanium carbide, for improving the friction values and for minimising wear. The winding cores for the purpose of a good cooling consist of metal with a good thermal conduction, e.g. of brass. A particularly good cooling effect can be achieved with hollow winding cores according to FIG. 15d with an internal feed channel and a discharge channel 33 for cooling water.

FIGS. 16-18 show photos of produced wound elements 5 according to the invention, of polypropylene PP with 50% glass-fiber reinforcement in the form of fourfold curls with 80 mm fiber length:

FIG. 16: several continuously manufactured wound elements before the separation
FIG. 17: individual wound elements as fourfold curls
FIG. 18 wound elements as granular material.

FIG. 19a, b illustrate the resulting much greater fiber lengths f in an injection moulded part which is manufactured with wound elements according to the invention, in comparison to granular material until now. Both samples are manufactured with a small injection moulding installation with only 35 mm screw diameter:

FIG. 19a with 10 mm LFT-rod granular material with 30% fiber share,
FIG. 19b with wound elements as fourfold curls with 80 mm fiber length f and 12% fiber share.

The figures show the large difference in the fiber lengths:
with material until now: fiber lengths f of 2-8 mm in FIG. 19a,
with wound elements: larger share of very long fibers with fiber lengths f of up to 80 mm in FIG. 19b.

FIG. 20a, 20b show a multiple-installation for the series manufacture of the wound elements 5 with a high production performance and productivity with a reduced spatial requirement and energy consumption. Thereby, simultaneously, several (e.g. 50) continuous fiber strands 3i are separately fed, wound off, impregnated (28i), in each case wound onto a rotating winding core (22i), advanced thereon, solidified and separated into individual wound elements 5i. This is analogous to the installation of FIG. 9a (without axial movement +x1, −x 1 of the winding cores 22i).

The winding cores 22i are additionally refracted (−x1) in step 43 and advanced (+x1) in step 44 with a multi-installation according to FIG. 20a, b, analogously to the installation of FIGS. 10 and 11a. For this, a linear drive 30 serves as an advancing unit which moves all rotating winding cores 22i together in the axial direction.

This method for the simultaneous manufacture of wound elements 5 of several impregnated continuous fiber strands 3i runs as follows:

(41) -separately winding-off several continuous fiber rovings 1i from winding-off units 11i and their impregnation with molten polymer material 2 in an impregnation tool 28 with several impregnation locations 28i,
(42) -winding up the impregnated continuous fiber strands 3i in each case about a rotating winding core 22i,
(43) -retracting −x1 and
(44) -advancing +x1 of the several winding cores 22i by way of a linear drive 30,
(45) -cooling and solidifying the windings and separating by way of a multiple separating device 27i, into individual wound elements 5i.

With this, one can process very many fiber strands 3i (e.g. 50) into wound elements 5i in a simultaneously rational manner with only one extruder 13, a melt device 12, a multiple impregnation tool 28i, a linear drive 30, a multiple cooling device 17i and a multiple cutting device 27i.

A component and a method for manufacturing a component of fiber-reinforced polymer material can be manufactured in a shaping process with wound elements 5 according to the invention. Such shaping processes, e.g. are formed by injection moulding, extruding, pressure extrusion, etc. Thereby, the wound elements with regard to shape, type and size can be mutually matched and optimised to the shaping processes and the shaping installation.

Essential advantages which are achieved with the continuously manufactured wound elements according to the invention as granular material by way of their construction and shaping are e.g.:
compact, round wound element granular materials with very large fiber lengths,
good pourability and improved feed behaviour,
greatly reduced loading of the fibers in the solid matter conveying region, and less fiber breakages due to this, resulting in much greater fiber lengths and a high share of long fibers in the component, e.g. injection moulded part, which is manufactured from this.

With this, significantly better mechanical characteristics of the manufactured components, particularly injection moulded parts, with regard to strength, stiffness and impact strength can be achieved. In particular, with existing shaping installations, e.g. with smaller injection moulding machines with small screw diameters

1. much greater fiber lengths of the wound elements can be processed and
2. with this, much greater fiber lengths in the component can be achieved.

The following reference numerals have been used in the framework of the description:
1 roving, filament of continuous reinforcement fibers, continuous fiber roving
2 matrix material, polymer material
3 impregnated continuous fiber strand
5 wound element (wound granular material)
6 turn
6a continuous winding
7 overlapping of 6
8 winding positions on 22, winding region, winding-up location
10 installation
11 roving feed, winding-off unit, reel
12 melting and impregnation device
13 polymer, matrix feed, compounder, extruder
14 heating of 12
17 cooling devices
17i multiple cooling device with several cooling locations
17.1 Venturi nozzle after 12
17.2 air cooling at the run-in of 3
17.3 cooling in front of 27
18 winding device
19 cooling device of 22
20 rotation motor for 22
20i rotation drives
21 rotation direction of 22
22 winding core
22a winding core of polymer material
23 winding axis
24, 24.2 guide plate for 3, guide elements
25 holding-back plate
26 guide element for 3 at 22
27 separating device, cutting device for 5
28 impregnation tool
28i several impregnation locations
29 reel with 22a
30 linear drive in the axial direction x, positioning drive for 22
32 longitudinal grooves
33 internal water cooling in 22
34 edges, ribs
35 control for 11, 12, 17, 18, 20, 27, 30, 19, 24
36 feed device
37 withdrawal device for 22a

### Method Steps 41-46:

41 winding off and impregnating 3
42 winding up of 3, 6
43 refraction of 22, advance of 6 on 22
44 advance of 22
45 solidification of 5 to 22
46 cutting off, separation of 5
51 curled 5
52 spiral-shaped 5
53 combined: 6 lying over one another and next to one another, mixed form
x axial direction of 23
x1 displacement path of 22
x2 displacement path of 24, 24.2
xa displacement path through 26
t time
s22 path of 22
s24 path of 24, 24.2
f fiber length

### Linear Dimensions of 5:

L length
B width
H height

1-21. (canceled)

22. A fiber-reinforced polymer material, in particular for processing in an injection moulding method and extrusion method, comprising:
granular materials with integrated long-fiber reinforcement,
wherein the granular materials are formed from polymer material as wound elements (5) which comprise continuous fiber strands (3) of continuous reinforcement fibers (1) impregnated with polymer material (2),
wherein said wound elements (5) contain more than one turn (6) of the impregnated continuous fiber strands (3), and
wherein the turns (6) in the wound elements (5) in a radial direction to the winding axis (23) at least partly are lying over one another.

23. A polymer material according to claim 22, wherein the wound elements (5) comprise at least two turns (6).

24. A polymer material according to claim, 22 wherein the ratio maximum/minimum of the linear dimensions (L, B, H) of the wound elements (5): max (L, B, H)/min (L, B, H) is at the most 2-3.

25. A polymer material according to claim 22, wherein the polymer material (2) comprises thermoplasts.

26. A polymer material according to claim 22, wherein the impregnated continuous fiber strands (3) in the wound element (5) have a fiber share of 20-60% by weight and fiber lengths (f) of more than 25 mm.

27. A polymer material according to claim 22, wherein the wound elements (5) comprise impregnated continuous fiber strands (3) and additional polymer material (2).

28. A method for the continuous manufacture of granular materials of long-fiber-reinforced polymer material in the form of wound elements (5), comprising the steps of:
(41) winding off a roving of continuous reinforcement fibers (1) and impregnating with molten or liquid polymer material (2) for forming an impregnated continuous fiber strand (3),
(42) about a rotating winding core (22) as a winding axis (23) and by means of guiding elements winding the impregnated continuous fiber strand (3) into turns (6) lying at least partly over one another for forming windings (6a),
(43) and thereby displacing the formed windings in the axial direction (+x),
(45) solidifying the windings (6a) by means of cooling or hardening during the further displacement in the axial direction (+x),
(46) subsequent cutting through the solidified windings (6a) at defined distances (L), and by way of this, the formation of individual wound elements (5).

29. A method for the continuous manufacture of granular materials of long-fiber-reinforced polymer material in the form of wound elements (5), characterised by a rotating winding core (22) as a winding axis (23) which is moved in axial direction (−x1, +x1) in an oscillating manner by means of a linear drive (30) for forming wound elements with turns (6) lying over one another and comprising the steps of:
(41) winding off a roving of continuous reinforcement fibers (1) and impregnating with molten or liquid polymer material (2) for forming an impregnated continuous fiber strand (3),
(42) winding the impregnated continuous fiber strand (3) for forming a wound element (5.1) in a winding position (8.1) on the winding core, subsequently (43) retracting (−x1) the winding core (22) and by way of this, advancing the already formed wound elements (5) on the winding core and subsequently (44) advancing (+x1) the winding core (22) and by way of this releasing a new winding position (8.2) for producing a next wound element (5.2)
(45) solidifying the wound elements (5) with a further advance (+x) on the winding core by means of cooling or hardening, and
(46) cutting through the impregnated continuous fiber strand (3) and thus separation of the individual wound elements (5) from one another.

30. A method according to claim 29, further comprising an additional displacement (+x2, −x2) of the run-in location of the impregnated continuous fiber strand (3) within the released winding position (8) by way of guide plates (24, 24.2) which can be adjusted in the x-direction.

31. A method according to claim 28, wherein a thermoplastic polymer material (2) is used in:
(41) impregnating the continuous reinforcement fibers (1) with heated, molten polymer material (2),
(45) cooling and thus solidifying the wound elements (5) on the winding core (22).

32. A method according to claim 31 for the simultaneous manufacture of wound elements (5) of several impregnated continuous fiber strands (3i), wherein:
(41) separately winding off several continuous fiber rovings (1i) from winding-off units (11i) and their impregnation with molten polymer material (2) in a multiple impregnation tool (28i)
(42) winding the impregnated continuous fiber strands (3i) in each case around a rotating winding core (22i)
(43) retracting (−x1) and
(44) advancing (+x1) the several winding cores (22i) by way of a linear drive (30).

33. A method according to claim 28, wherein a rod of fiber-reinforced polymer material (2) is premanufactured and is applied as a winding core (22a) and together with the wound elements (5) is separated into individual wound elements (5) by way of a separating device (27), wherein the winding core (22a) is advanced in the axial direction (x) by way of a feed device (36) and a withdrawal device (37) and is rotated about the winding axis (23).

34. An installation for the continuous manufacture of granular materials of long-fiber reinforced thermoplastic polymer material in the form of wound elements (5), comprising:
a winding-off unit (11) for a roving of continuous reinforcement fibers (1), a subsequent melt feed (13) of thermoplastic polymer material (2) and a melt and impregnation device (12) for forming a molten, impregnated continuous fiber strand (3)
a winding device (18) with a winding core (22) for winding, cooling and solidifying the impregnated continuous fiber strand (3) and for forming wound elements (5) with more than one turn (6) and with turns (6) lying over one another,
with a rotation motor (20) for the drive of the winding core (22) with a cooling device (19)
and with a linear drive (30), with which the winding core (22) can be moved in the axial direction in an oscillating manner (−x1, +x1)
for retracting (−x1) the winding core (22) and by way of this for advancing the formed wound elements (5) on the winding core
and for the subsequent advance (+x1) of the winding core, and by way of this for the release of a next winding position (8.2) for winding a next wound element (5.2),
with a cooling device (17) for cooling and solidifying the wound elements (5) on the winding core
and with a separating device (27) for separating the individual solidified wound elements (5) as well as with a control (35) of the installation.

35. An installation according to claim 34, wherein the winding core (22) is designed metallically, slightly conically (31) and with longitudinal grooves (32) or with edges (34) and/or that it has an inner water cooling (33).

36. A component of fiber-reinforced polymer material (2), wherein the component is manufactured in a shaping process with wound elements (5), according to claim 22.

37. A method for manufacturing a component of fiber-reinforced polymer material (2), wherein the component is manufactured in a shaping process with wound elements (5), according to claim 22.

38. A method according to claim 29, wherein a thermoplastic polymer material (2) is used in:
(41) impregnating the continuous reinforcement fibers (1) with heated, molten polymer material (2),
(45) cooling and thus solidifying the wound elements (5) on the winding core (22).

39. A method according to claim 29, wherein a rod of fiber-reinforced polymer material (2) is premanufactured and is applied as a winding core (22a) and together with the wound elements (5) is separated into individual wound elements (5) by way of a separating device (27), wherein the winding core (22a) is advanced in the axial direction (x) by way of a feed device (36) and a withdrawal device (37) and is rotated about the winding axis (23).
